(19) United States
(12) Patent Application Publication
(10) Pub. No.: US 2006/0002469 A1
(43) Pub. Date: Jan. 5, 2006

(54) Method of video data transmitting

(75) Inventors: Andrey V. Zurov, St. Petersburg (RU); Sergey V. Novikov, St. Petersburg (RU); Alexander P. Tanchenko, St. Petersburg (RU)

Correspondence Address: Mark S. Svat, Esq.;Fay, Sharpe, Fagan, Minnich & McKee, LLP, Seventh Floor, 1100 Superior Avenue, Cleveland, OH, 44114-2579, US

(73) Assignee: Comet Video Technology

(21) Appl. No.: 11/170,831

(22) Filed: Jun. 30, 2005

Related U.S. Application Data
(60) Provisional application No. 60/584,364, filed on Jun. 30, 2004.

(51) Int. Cl. H04B 1/66; H04N 5/14; H04N 11/02; H04N 9/64; H04N 11/04; H04N 7/12

(52) U.S. Cl. 375/240.12; 348/700

(57) ABSTRACT

A method of video data transmitting by means of video data reconstruction on the receiving end of the communication channel per time unit, based not only on the data, transmitted directly via the channel, but on all previously transmitted, decoded and stored video data.

### INCORPORATION BY REFERENCE

U.S. Pat. No. 5,321,776 to Shapiro and U.S. Pat. No. 5,764,807 to Pearlman et al. are both hereby incorporated by reference in their entirety.

Reference is also made to U.S. patent application Ser. No. ______, filed Jun. 29, 2005 entitled, “METHOD OF DATA COMPRESSION INCLUDING COMPRESSION OF VIDEO DATA, by Andrey V. Zurov et al.

The present application claims the benefit of Provisional Patent Application No. 60/584,364, filed Jun. 30, 2004.

The disclosure of both above-identified applications are incorporated herein in their entirety, by reference.

### FIELD OF THE INVENTION

The present invention is a technique of video data transmitting over low bit-rate communication channels mostly in real time mode.

### BACKGROUND OF THE INVENTION

The main problem for video data transmitting over low bit-rate communication channels lies in maintaining high image quality. This problem is solved by various methods of digital video data compression, the main method being a frame sequence coding by MPEG procedure. This procedure is based on display of digital video data received from the image source as an aggregate of groups of pictures (GOP), each GOP starting with a key frame (I-frame) and containing a limited number of predictive frames (P-frames), usually connected to the I-frame through the same image scene. The I-frame makes the first frame of the scene, and is followed by GOP P-frames, that are very similar to it as well as to each other. The next stage of MPEG procedure is compression of GOP digital video data. The I-frame compression is performed by one of the known methods, for example by method of two-dimensional spectral decomposition with subsequent representation of resulting spectral coefficients as a flow of digital data, organized in accordance with the influence of these coefficients on the image quality, with coefficients corresponding to the lower spatial frequencies placed in the beginning of the flow. The compression of GOP P-frames is based on high predictability of each subsequent P-frame as compared to preceding GOP frame. Known as predictive coding, this procedure implies the following: an image of the frame, that serves as a source of subsequent content predicting for coded frames, is divided into rectangular blocks of pixels. Then the search for image blocks of the same size, maximally close in contents to the blocks of preceding frame, is done for the coded frame. After such blocks are found, their location is fixed on the coded frame with respect to preceding frame by setting a displacement vector. For the image parts of the coded P-frame, to which no prototypes from the previous frame could be found on the basis of predetermined criteria, the standard coding procedure similar to the coding of GOP I-frames is applied. Thus, predictive coding algorithm helps to substantially reduce the GOP data volume down to the volume, comprising the coded GOP I-frame, arrays of displacement vectors of encoded image blocks for each GOP P-frame, as well as volumes of encoded image blocks of P-frames without prototypes from preceding GOP frames.

MPEG procedure is universal and secures a relatively high level of video data compression. However for individual applications,—such as transmitting video data from conferences, or data of video survey of slow-moving or periodically reproducing objects over low bit-rate communication channels in real time mode,—the algorithm of bit flow formation can be improved to enhance the quality of the images transmitted.

The objective of the invention is to enhance the video image transmitting quality. It is achieved through buildup of the number of frames transmitted per time unit by reducing data volume per transmission of the flow of frames, located on such a distance, when the number of frames coming from the image receiver (said, from video camera) exceeds the number of the coded frames, which can be transmitted over the communication channel in the same period of time.

### SUMMARY OF THE INVENTION

In order to ensure high quality of video data transmitting over low bit-rate communication channel one must first of all understand and specify key factors that determine perception of the video range by a spectator. Many experiments carried out by the authors with respect to individual peculiarities of human perception have proved, that the quality of video information is determined less by sheer volume of video data, received by spectator per time unit, but by the smoothness of image details transformation. In other words, the spectator has much higher estimation of the quality of image, where small details can be omitted or distorted, as compared with image, where delays in video sequence create a “slide-show” effect, even provided each frame has perfect quality. Considering the task of video data transmitting in real time, the problem of high video image quality turns out to be intractable, because no effective method known to the authors offers solution for the situation, when the quantity of bits of encoded video data of desired quality and frame rate exceeds the capacity of the channel.

The essence of the invention lies in a method of video data transmitting by means of video data reconstruction on the receiving end of the communication channel per time unit, based not only on the data, transmitted directly via the channel, but on all previously transmitted, decoded and stored video data. The advantage of the claimed method helps to avoid the “slide-show” effect when the transmitted image is periodically repeated, as, for example, at video conference coverage.

In compliance with invention the method of video data transmitting has two possible step sequences:

In compliance with the first aspect of the invention, the claimed method means coding of video data as a sequence of key frames and predictive frames, with selection and coding of the first frame of said sequence as a key frame, followed by transmitting of the coded frame over low bit-rate communication channel, its decoding and storage of results at the transmitting and receiving ends of communication channel. The subsequent frame F(J) assigned to coding is chosen from a frame sequence, which is going out of the video data source. Number J of this frame in the source frame sequence is calculated by formula J=INT(NQ/W), wherein N is a video data source frame rate, Q is a number of bits transmitted over the channel, W is capacity of the communication channel, and INT(x) is a function for integer part calculation. Then the type of coding for said frame should be set. For this purpose the array of frames transmitted, decoded and stored at the transmitting end is searched for a frame R(r), which is closest to the current frame assigned to coding. If the difference value D1 between the previously transmitted and decoded frame and the current frame assigned to coding determined by any method, does not exceed the predetermined threshold value Th, the current frame F(J) is coded as a predictive frame with respect to the pre-chosen transmitted frame R(r), transmitted and stored at both receiving and transmitting ends of the communication channel. Otherwise the current frame shall be coded as a key frame in accordance with above-mentioned procedure.

In compliance with the second aspect of the invention, the claimed method means coding of video data as a sequence of key frames and predictive frames, with selection and coding of the first frame of said sequence as a key frame, followed by transmitting of the coded frame over low bit-rate communication channel, its decoding and storage of results at the transmitting and receiving ends of the channel. The subsequent frame F(J) assigned to coding is chosen from a frame sequence, which is going out of the video data source. Number J of this frame in the source frame sequence is calculated by formula J=INT(NQ/W), wherein N is a video data source frame rate, Q is a number of bits transmitted over the channel, W is capacity of the communication channel, and INT(x) is a function for integer part calculation. Then the type of coding for said frame should be set. For this purpose the array of frames transmitted, decoded and stored at the transmitting end is searched for a frame R(r), which is closest to the current frame assigned to coding. If the difference value D1 between the previously transmitted and decoded frame and the current frame assigned to coding determined by any method, exceeds the predetermined threshold value Th, then the group of frames, preceding the current frame, shall be searched for frame F(j), which is the closest to previously transmitted frame R(s). If the difference value D2 between these two frames does not exceed threshold value Th, the chosen frame F(j) shall be coded as a predictive frame with respect to preceding prototype frame R(s), transmitted instead of the current frame and stored both at the receiving and transmitting ends of the communication channel. Otherwise the current frame F(J) shall be coded like a key frame as described above.

### SHORT DESCRIPTION OF THE DRAWINGS

FIG. 1 shows a diagram, illustrating the first aspect of the claimed method.

FIG. 2 shows a diagram, illustrating the second aspect of the claimed method.

FIGS. 3-16 illustrate alternative and/or detailed concepts of the present application.

### DETAILED DESCRIPTION OF THE INVENTION

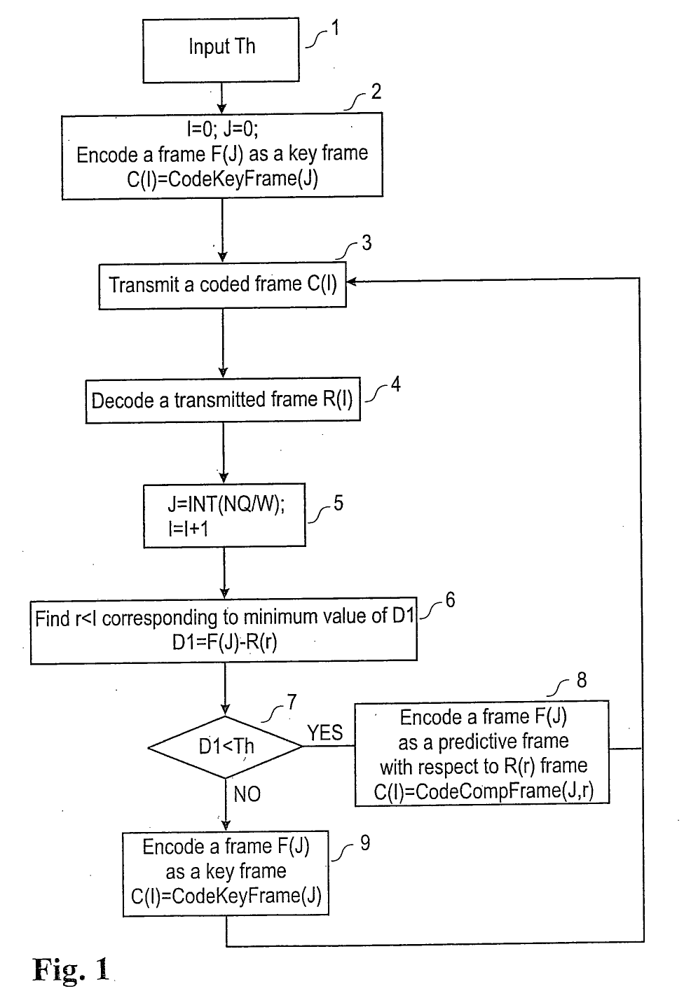

In compliance with the first aspect of the invention for implementing the claimed method of video data transmitting over the low bit-rate communication channel, it is necessary to calculate a numerical value, representing selection criterion of coding type for the frames of the video sequence. As shown on the diagram from FIG. 1, the first step to accomplish the method is to enter the specified numerical threshold value Th 1. Evidently any frame sequence, received by the communication channel from the source output, can be displayed as an aggregate of frames assigned to coding at least in two different ways: 1) as key frames, i.e. regardless other frames, and 2) as predictive frames, i.e. with respect to preceding coded frames. At the start of the video data transmission as well as at the beginning of every new scene in the image, a frame F(J) appears, which is selected to be coded as a key frame because of its contents. Such coding 2 makes the second step of the operation sequence for the claimed method. Then the coded frame goes to the input of communication channel and is transmitted 3, making the next step of the method. In the course of data transmission the number of bits Q, that actually pass over the channel, is determined; then the image of the transmitted frame R(r) is decoded 4 and stored at the transmitting end of the channel. Due to the fact that duration of coded frame transmission over the low-bit communication channel exceeds the time interval between the adjacent frames of video sequence, received by the communication channel from the output of the video data outlet, a number J of the next frame assigned to coding from the sequence shall be determined before the end of previous frame transmission. Such calculation 5 is done by formula J=INT(NQ/W), wherein N is the video data source frame rate, Q is a number of bits transmitted over communication channel during the preceding frame transmission and W is the capacity of communication channel. After defining the number of the subsequent frame assigned to coding it is necessary to determine the type of coding, that is to decide whether this frame shall be coded as a key frame or as a predictive frame with respect to some previously transmitted frame. Apparently the second type of coding is preferable, for the volume of data transmitted for the image is less, while the quality remains the same. In order to choose the type of coding for the subsequent frame of the video sequence, the value of absolute difference D1 between the frame F(J) assigned to coding and each of the previously transmitted, decoded and stored at the transmitting end of the channel frames R(r) is calculated. From the set of values obtained for D1 the minimum value shall be selected 6 and compared with value Th 7. If the value D1 does not exceed Th, the subsequent frame F(J) assigned to coding shall be encoded as a predictive frame 8 with respect to frame R(r), for which D1 has the minimum value. If condition D1<Th is not fulfilled, the frame F(J) shall be encoded as a key frame 9. The frame, coded in one way or another, goes through communication channel, and the process of data transfer proceeds till the last frame is transmitted from the video data source.

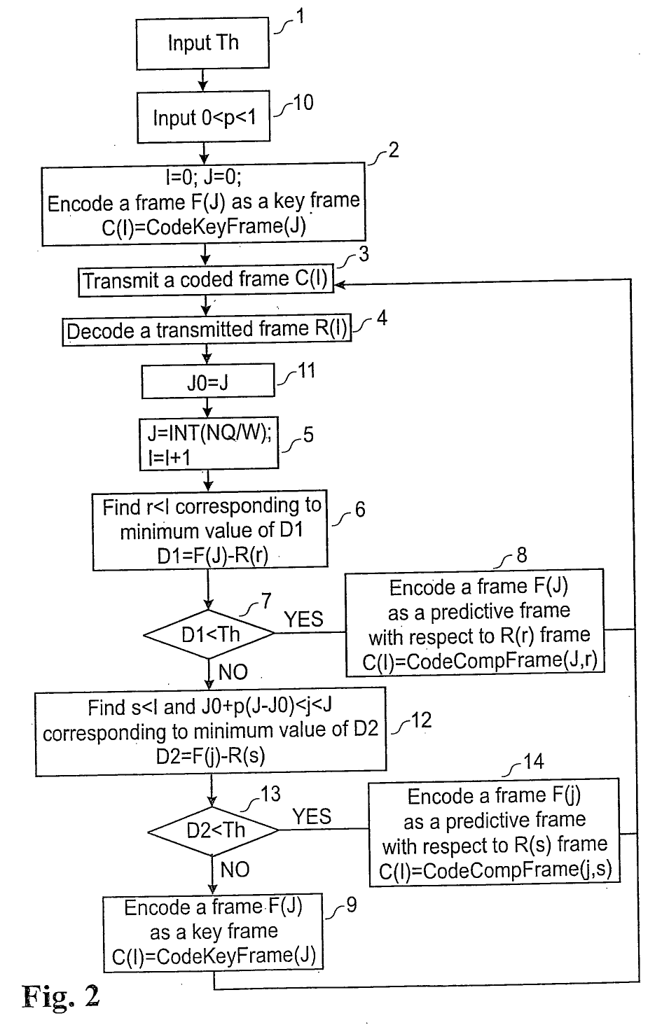

The quality of transmitted video image can be further enhanced by implementing the claimed method in compliance with the second aspect of the invention, as illustrated by diagram from FIG. 2. When entering source data as required by the second aspect of the invention, data input 1 of the value Th shall be accompanied by selection of p parameter in range from 0 to 1 and its input 10.

Steps 2-4 and 5-8 of the operation sequence, as required by the second aspect of the invention, has been already described above. In compliance with the second aspect of invention, saving 11 of the number J0=J of the preceding frame for the frame sequence of video data source shall take place prior to Step 5.

Let us have a closer look at the situation when Step 7 of video data transmitting method as required by the second aspect of the invention leads to non-fulfillment of condition D1<Th. It means that the frame to be coded and transmitted cannot be encoded as a predictive frame. At the same time, though no matching frame received from the video data source till the end of preceding frame transmission exists, it is still possible to find a frame among previously encoded and transmitted set frames, similar to one of the frames, received from the source at the input of communication channel during video data passage from preceding frame. In order to define this frame, the absolute difference D2 between each frame R(r), previously transmitted, decoded and stored at the transmitting end of the channel, at the one hand, and each frame F(j), received from the video data source within the range of numbers J0+p(J−J0)<j<J, at the other hand, shall be calculated. From the set of D2 values, received by these means, the minimum value shall be chosen 12 and compared to the value Th 13. If value D2 does not exceed Th, the frame F(j) shall be coded as a predictive frame 14 with respect to frame R(s) of minimum D2 value. If D1<Th is not fulfilled, frame F(J) is coded as a key frame 9. The frame encoded by either method goes into the communication channel, and the process of data transfer proceeds till the last frame is transmitted from the video data source.

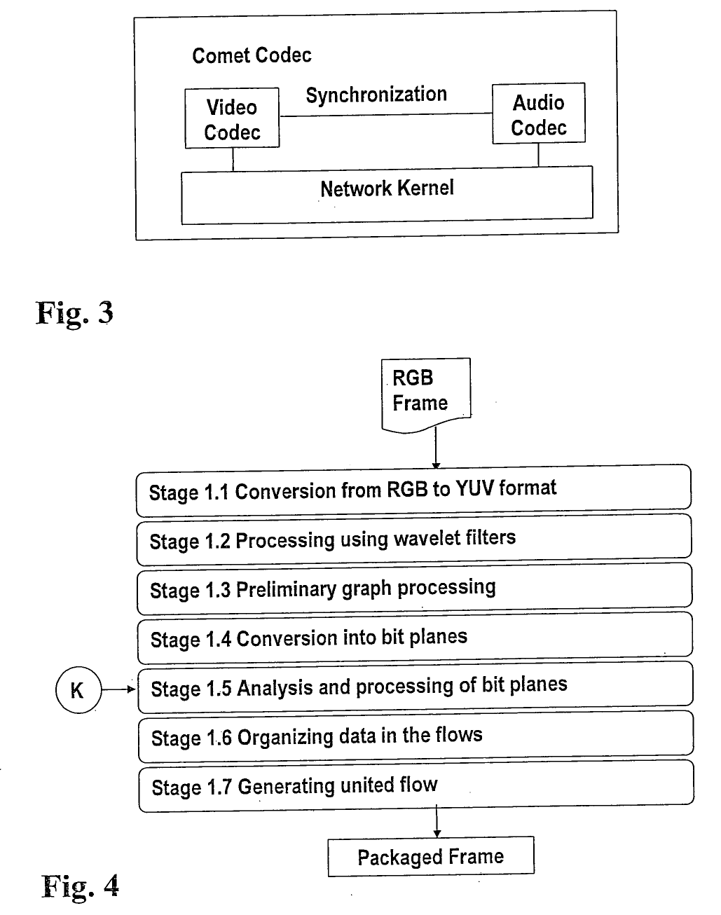

With continuing attention to the present application, disclosed below is the Comed Codec Operation Plan as shown in FIG. 3, where Comet Codec consists of three blocks:
Video Codec
Audio Codec
Network Kernel

All the three blocks interact in order to secure synchronized audio and video encoding and also for automatic adjustment of codecs when changing the communication channel or when the connection is terminated.

Video Codec

Video Codec carries out encoding and decoding using wavelets of video flows. The given processor has the following work cycle:
Preprocessing
Encoding of key frames
Compensating models
Decoding of key and compensated frames
Postprocessing

Preprocessing—the necessary video image preparation for the following encoding, i.e. enhancement of quality (on the basis of available from the previous frames statistics).

Encoding of keyframes is carried out on the basis of developed video compression methods using wavelet technology.

Compensating methods enable to transmit greater number of frames due to the fact that only the difference between them is being transmitted. This method should be closely connected with Preprocessing. The Compensating Methods should be also closely connected to the Network Kernel, because they are mostly dependent on the network disturbances. Encoding of compensated frames is also carried out on the basis pf wavelet technology.

Decoding of key and compensated frames is realized using back-encoding using wavelet technology.

Postprocessing is aimed at video quality enhancement by means of applying filters to video image for sharpness and color spectrum improvement.

1. Key Frame Packaging is Illustrated in FIG. 4

The packaging process consists of seven stages as shown by FIG. 4.

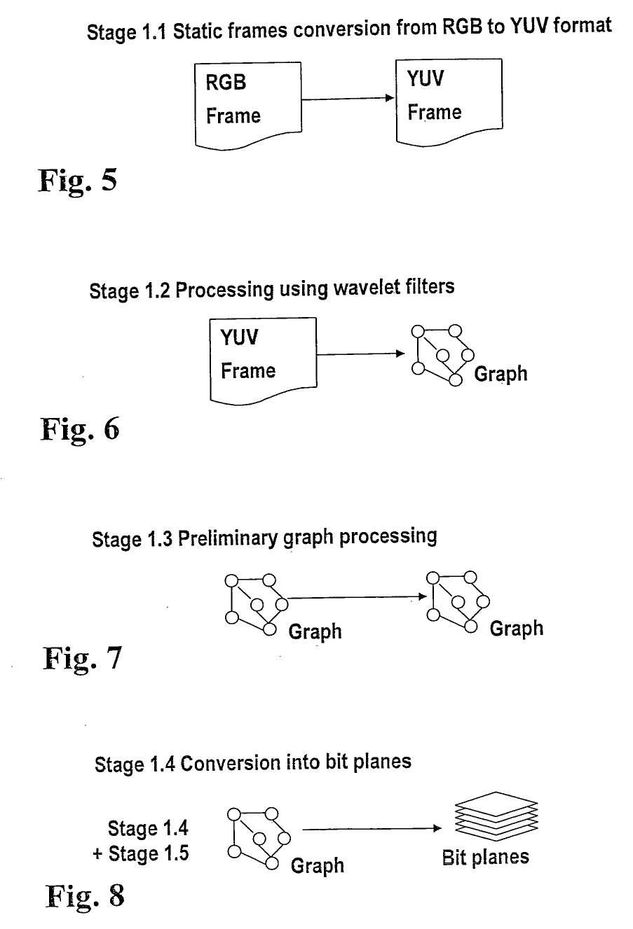

Description of Stage 1.1 as in FIG. 5: static frame in the RGB format is inputted. The frame is constituted of three planes: red, green and blue that together make up an image. Using standard, one-one functions, static frame is converted to another format called YUV, that, in its turn, is also a unity of three planes: brightness constituent Y and two color sub carriers, modulated by color signals U and V. The most used formulas for YUV conversion:
Y=0.299*R+0.587*G+0.114*B
U=0.564*(B−Y)
V=0.649*(R−Y)

Such presentation of an image is more informative for further analysis.

Description of Stage 1.2 as in FIG. 6: Static frame in YUV format is inputted. With the help of two filters based on wavelets the image is being resolved into 2 constituents: high frequency and low frequency. The conversion is one—one and at the output is presented as a graph at the junctions of which the coefficients, as the result of resolution are located. The arcs are the connections between the coefficients. In order to resolve a frame into a graph wavelet filters are used. The wavelet filters were selected experimentally and are the fittest for video packaging. (However, the wavelet filters can be easily modified, if necessary). The wavelet filters are hard coded in the program as at the transmitting side as well as at the receiving one (they should be similar at both sides).

Description of Stage 1.3 as in FIG. 7: In order to package the data at stages 4 and 5 the graph at stage 3 should meet the definite requirements.

Each graph junction, except for the most upper, should have a “parent.” At stage 3 we check a graph from stage 2 and complete it, if necessary, i.e. we indicate “parents” for the junctions that don't have any.

Description of Stage 1-4 as in FIG. 8: Beginning from this stage the packaging process starts. In order to make analysis at stage 5, graph from stage 3 should be subject to unique treatment and transformed into unique machine representation—bit planes.

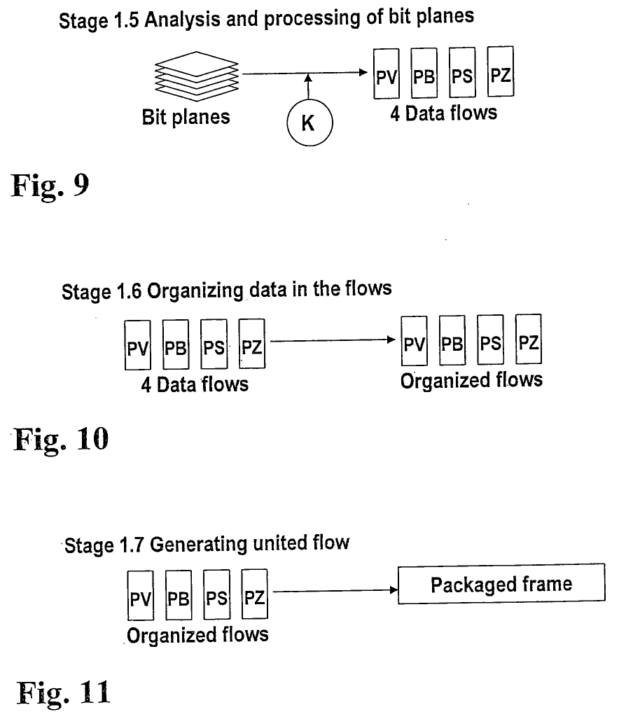

Description of Stage 1.5 as in FIG. 9: The bit planes and contained there data from stage 4 are being analyzed. On basis of this analysis, we organize data within bit planes according to their significance. Then depending on the compression ratio value that Is used on this stage, we cast out all the data that is insignificant at this stage. (The greater compression ratio value, the more data is cast out). The data that remains is sorted out into 4 different data flows.

Description of Stage 1.6 as in FIG. 10: In order to achieve greater data compression, the data in the flows is organized in a special way and is subject to additional statistic analysis.

Description of Stage 1.7 as in FIG. 11: Organized flows are united into integrated structure, that is a packaged frame. The structure is then transferred for sending through network.

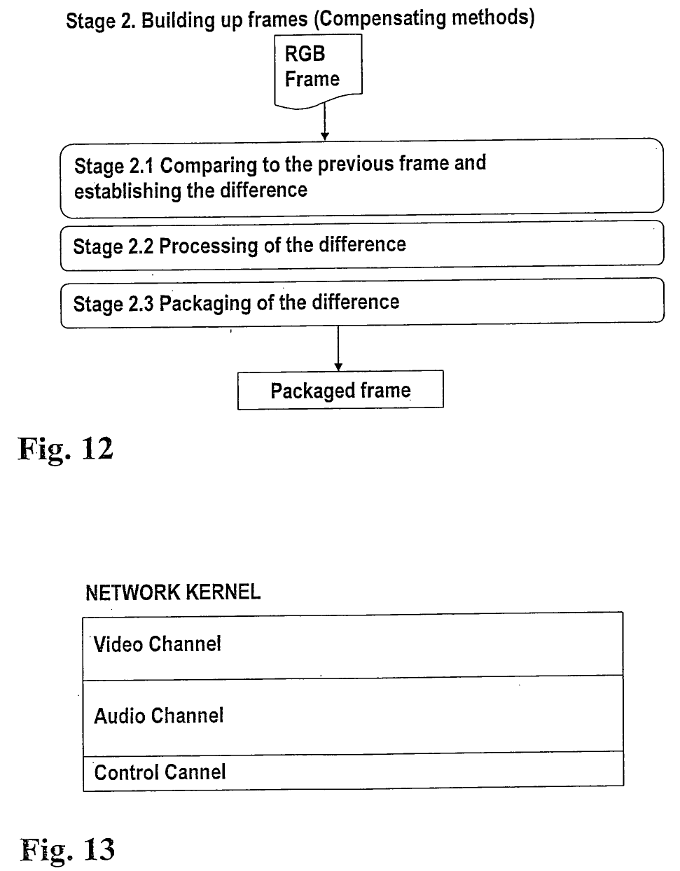

2. Building Up Frames (Compensating Method) (Shown in FIG. 12)

Stage I. Comparing to the Previous Frame and Establishing the Difference

Description: A static frame is inputted. The difference with the previous frame is established. There may be two variants: establishing the difference with the previous frame or establishing the difference with the previous basic frame. The first variant presupposes the smaller difference, but its absence in the communication moment will not allow building up the next frame. The second variant presupposes the greater difference, but absence of the frames will not be crucial.

Stage 2. Processing of the Difference

Description: The difference is being processed in order to cut out the unnecessary data and make it more compact (compression).

Stage 3. Packaging of the Difference

Description: For packaging the modification of key frame packaging method is used.

Audio Codec

Audio Codec encodes the audio flow synchronically with the video flow. The sound encoding implies the original realization of psycho-acoustic model of sound encoding. This realization has enabled to transmit the human speech using the 1400 BPS channel. A Network Kernel (such as shown in FIG. 13 should secure the well-timed delivery of data and is responsible for monitoring of the network for the purpose of network disturbances detection and basing on the statistics accumulated carries out the adjustment of Video and Audio Compressors. Picture displays the structure of the one-way data transfer channel (requirements for this channel are listed below). This channel consists of three flows:
Video Channel
Audio Channel
Control Channel

Video Channel is responsible for video frames delivery from Video Compressor.

Audio Channel is responsible for audio flow delivery from Audio Compressor.

Control Channel is responsible for a wide range of service functions:
Carrying out of connection of two or more users of the clients programs before the communication session starts.
Synchronizing of video and audio flows.
Network.
Notification on network disturbances and data loss.
Carrying out of short messages exchange between the users (chat).

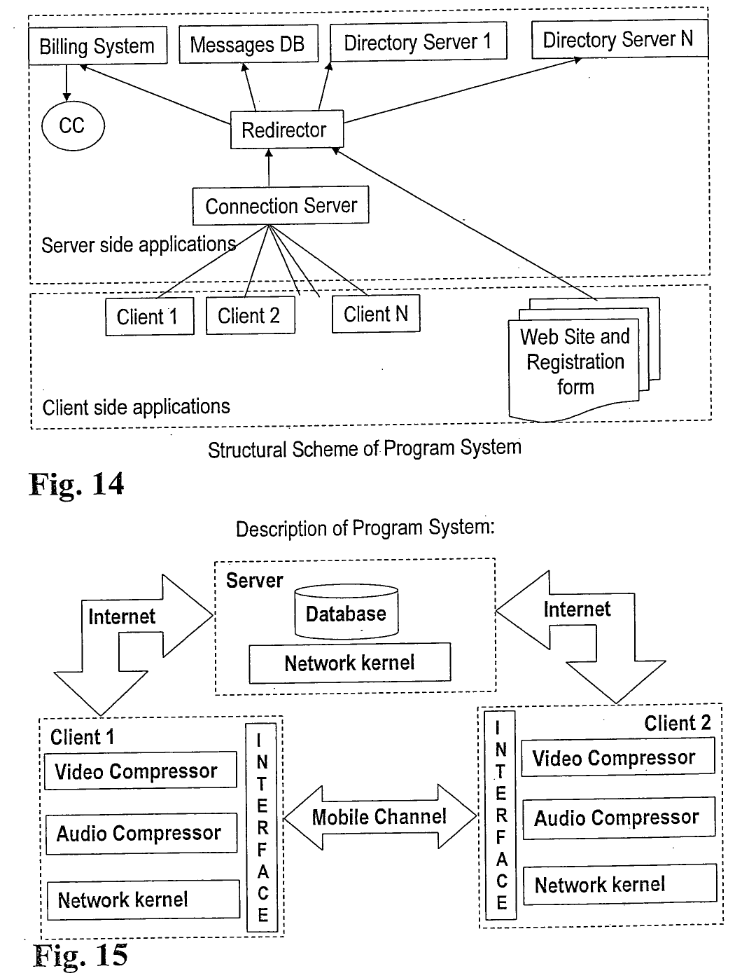

FIG. 14 illustrates requirements and functional specifications for the development of the program system for video conferencing over the internet.

All the system users must register at web site where they enter their name, e-mail and password for the system login. After a user has been registered, the system assigns to each user a unique number (U 1 D).

After the user has been registered in the system he/she can upload the PS to his/her own computer and install it.

A client can also pay with the credit card for additional services (options) in the system. The payments are carried out through CyberCash system and are registered on the Billing server.

Client Application

Client application gas the following functions:
1. View and search for users in the database. This option is available in all versions of PS.
2. Request for authorization to add users to the Contact List. A user is added to the Contact List after authorization. This option is available in all versions of PS.
3. Sending of short messages to a user from the Contact List. This option is available in all versions of PS.
4. Chat with a user from the Contact List. This option is available in all versions of PS.
5. Viewing of audio and video flows from users that can translate video and audio flows and that have authorized the user to view video and audio flows. This option is available in all versions of PS.
6. Video conferencing point-to-point with another user of the system that is authorized to perform video conferencing. Video conferencing is available for users that paid for this option.
7. Video translation for multiple users. This option is available for users that paid for the authorization of video translating.

Requirements for client’s hardware:
Intell PC with processor PII Celeron 600 MHz and
Memory 64 Mb and more
Sound card
Video camera
Either standard modem 56 BPS for dial-up connection or
Network card for connection to 10/100 MB network

Requirements for client's software:
OS Windows 98 OSRI, Windows Me, Windows 2000
Set of Direct Show drivers (cameras and sound cards must be compatible with the drivers)
TCP/IP protocol driver
   Server Applications

1. Connection Server.

Connection Server is an entry point for all users of the system. It carries out the following functions:
Request for UID and password for registration in the system
Securing of permanent connection with the user during the session
User's status test
Keeping the users list that are online at the current moment
Data communication between the client and higher services (for their description see below)
Sending of short messages to the user and their storage In Message DB in case of failure

2. Redirector

Redirector is a thin layer between the Connection Server and higher services. It is responsible for balancing the load of higher services.

3. Directory Servers

Directory Servers store the distributed database of users and their Contact Lists. Redirector server is responsible for the load of these servers.

4. Messages DB

Messages DB—is the server of unsent messages. All the messages that due to any reasons could not be delivered to the addressee by the Connection Server are sent to the Messages DB. When a user logs in the system, the Connection Server checks the availability of unsent messages for this user and if there are any, it send them to the user.

5. Billing System

The system of user accounts storage. For each registered system user there is a personal account. As default if is empty, i.e. after a user has been registered in the system, he/she has access to free system services only. If a user wants to make payments for additional services, he/she can do it using the credit card (via CyberCash system). When a user logs in the system, the Connection Server requests for his/her status at the Billing System and based on the user's status assigns the access to additional services.

Requirements for server hardware in one embodiment:
Server with processor PIII 600 MHz and faster
Memory 128 Mb and more

Requirements for server software in one embodiment:
OS Windows 2000 Server
MSSQL Server 2000

FIG. 15 illustrates the functional specifications for the development of a program system for compression and transmission of video images.

The purpose of this project is development of program system (further referred as PS) for compression and transmission of video images using low bandwidth channels of wireless communication of all existing standards. The given PS is intended for carrying out of video conferences and video transmissions in real time mode using wireless communication and it will be used as prototype for hardware implementation. The technology being developed that is basic technology for PS must be also adaptable and scalable for wide channels (56 BPS and higher). This fact would allow to extend the PS to the video film broadcast system.

### Structural Scheme of Program System

Client Part.

Client part is an independent program that was installed on user's PC and that enables the user to transmit real time video images to or to carry out real time video conference with another user who has the same program installed on his PC. The connection to another user is realized either using wireless communication channel (direct connection) or using Internet (or other TCP/IP networks). In case of connection using Internet (or other TCP/IP networks) client part should be able to contact with server program and to request about users who are connected to the network at the moment.

Client part includes:
Video Compressor
Encodes video flow from video camera and transmits it to Network Kernel
Decodes video flow from Network Kernel and transmits it to user's display
Receives from Network Kernel network disturbances statistics and corrects video flow parameters
Audio Compressor
Encodes audio flow from soundmap and transmits it to Network
Decodes audio flow from Network Kernel and transmits it to soundmap
Receives from Network Kernel network disturbances statistics and corrects audio flow parameters
Network Kernel
Realizes the connection between the two users
Realizes network data reception and transmission
Realizes control of transmitted data integrity
Realizes network monitoring and transmits network disturbances statistics to Audio and Video Compressors

Description of data transmission principles are to be found in Network kernel description.

Requirements for client's hardware:
portable PC with processor PII Celeron 600 MHz and
memory 64 Mb and more sound card
sound card
video camera
connection device for connection to wireless communication channel
either standard modem 56 BPS for dial-up connection or
   Plan-Schedule of Works on the Project

Works on the project are realized in six stages.

1st stage Conciliatory and Preparatory. Presentation of the current version of the program.

During this stage the following work content should be accomplished:
Developer prepares technical documentation and program modules of the current version of program for video compression for presentation;
Developer sets the task to personnel and makes sure that the personnel adequately understands the project requirements;
Developer presents the current version of the program. During the presentation the Developer should demonstrate:
   1. Client part with possibility of direct connection by using mobile phone and connection via Internet.
   2. Realization of Video Compressor that operates observing the hardware and software described in the given Requirements Specifications.
   3. Realization of Video and Audio Compressors that have compensating mechanism and that transmits video and audio flows in conferencing mode performing the acceptable quality with rate of 3 frames per second using full duplex wireless communication channel with bandwidth 9500 BPS and higher.
   4. Realization of the current version of user interface.
      5. Realization of chat functions.
      6. Drawing up test record sheets of the current version of the program that is capable to secure video flow transmission using 9600 K5 channel.

2-nd stage <<Development of New Version>>.
Complete realization of server part.
Development, reconciliation and introduction of new version of user.
Realization of Region of Interest methods.
Realization of two versions of Compensating models. Securing of interaction between these methods and Network Kernel, that will automatically change the settings of methods depending on the network disturbances statistics.
Realization of Audio Compressor (the expected audio flow bandwidth 1500 BPS)
Testing of the system with different OS, communication networks standards and hardware.
Presentation of new version.
Drawing up test record sheets of the current version of the program.
Transfer source codes to the Customer on the paper media.

3-d stage <<Preparatory work for realization of hardware version of codec>>.
User should have at his disposal a mechanism of adjustment to different channel bandwidth, comprehensible functions for quality adjustment of video and audio flows. All the specific settings of Video and Audio Compressors should be realized automatically without user's
User should also have at his disposal volume settings panel and video camera parameters settings
User must be notified by program about the incoming call and be able to shut off the undesired calls
User should have at his disposal the chat function
   Server Part.

Server program is designed for the purpose of making easier the search and connection of client part users using Internet connection (or any other TCP/IP network). Server part is a scalable data base of the program users that can register and trace all the users connections to the client part of the network. Each program user when connected to the network can register on the server, add other users to his/her address book and to view the current status of any user listed in the address book. If the required user is online at the moment the server part should secure the possibility of fast connection to this user without making extra adjustments.

The main task of the billing system is to settle accounts with users for the time of using the channel. Payments for using the channel are collected for each minute. The cost of one minute is determined for each channel with possibility to introduce special tariffs for holidays, for example. Each client has a personal account. The money to this account is transferred from the client's credit card. Replenishment of the account is carried out by actual money transfer or by getting free minutes within the frames of advertising campaigns. Video broadcast servers send the requests to the billing server using http protocol. One billing server can serve several video broadcast servers.

Requirements for server hardware for one embodiment:
Server with processor PE 6D0 MHz and faster
Memory 128 Mb and more

Requirements for server software for one embodiment:
OS Windows 2000 Server

Requirements for the server part for one embodiment:
Server must have the standard scalable data base that supports unlimited number of
Server must process not less than 10 D requests per second from client programs

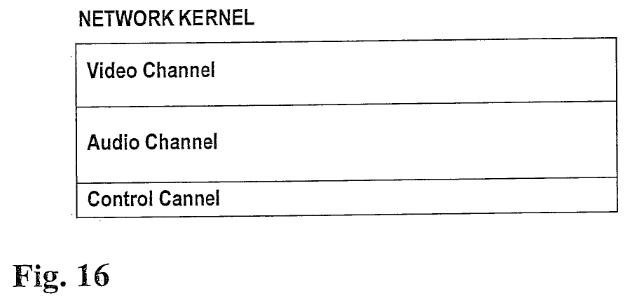

Network Kernel (such as FIGS. 13 or 16) should secure the well-timed delivery of data and is responsible for monitoring of the network for the purpose of network disturbances detection and basing on the statistics accumulated carries out the adjustment of Video and Audio Compressors. Picture #3 displays the structure of the one-way data transfer channel (requirements for this channel are listed below. This channel consists of three flows:
Video Channel
Audio Channel
Control Channel

Video Channel is responsible for video frames delivery from Video Compressor

Audio Channel is responsible for audio flow delivery from Audio Compressor

Control Channel is responsible for a wide range of service functions:
Carrying out of connection of too or more users of the clients programs before the communication session starts
Synchronizing of video and audio flows
Network
Notification on network disturbances and data loss
Carrying out of short messages exchange between the users (chat)

Network Kernel requirements for one embodiment:
Control of data adequacy
Continuous network monitoring
Accumulating of network disturbances statistics and capability of operation with Video and Audio Compressors settings
Availability of intelligent algorithms for working with Compensating
Realization of chat functions
Scalability—the possibility to send one video flow to many
   Interface

User Interface (GUI) must provide convenient and intuitively comprehensible form of managing the client program. GUI must secure an easy way of operation with program settings and simple and convenient connection to another user.

Requirements for User Interface (GUI) for one embodiment:
User Interface must be simple and intuitive
Interface must have a pleasant modem design
User Interface must consist of two dialogs for viewing the incoming and outgoing video flows
User should have the possibility to enlarge the size of the dialogs up to the size of the screen and to return the dialogs to the reset state

Video Compressor should be capable for flexible adjustment during the video flow encoding process based on the statistics accumulated during the encoding process and on the statistics accumulated at and received from Network Kernel.

Requirements for Video Compressor for one embodiment:
Video Compressor should realize simultaneous encoding and decoding of video flow in conferencing mode including preprocessing and postprocessing following the software and hardware requirements mentioned above
Video Compressor must provide symmetrical scheme of encoding and decoding
The number of processed frames per second should be 5 and more performing the acceptable quality using channel with bandwidth of 9600 BPS
Compensating model should secure gradual quality Increase of static image
Compensating model should be able to process possible network disturbances
Compensating model must be realized in two variants: for networks that guarantee data delivery (for further hardware implementation using such networks) and for networks that do nor guarantee data delivery (for networks of the Internet-type)
   Audio Compressor

Audio Compressor carries out encoding and decoding using wavelets of audio flows. The realization of the given module must advance in two directions: use of available in the market standardized audio flow compression algorithms and analysis of possibilities to develop own audio codec based on the wavelet technology.

Requirements for Audio Compressor for one embodiment:
Audio Compressor should realize simultaneous encoding and decoding of audio flow together with video in conferencing mode following the software and hardware requirements mentioned above
Audio Compressor must provide symmetrical scheme of encoding and decoding
Audio Compressor work must be synchronized with the video one when Sound quality must be sufficient for understanding the human speech
Audio data volume must not exceed 240D BPS using channel with bandwidth of 9600 BPS. The ideal volume is 1000 BPS
Audio Compressor should be able to process possible network disturbances.
Network card for connection to 10/100 MB network

Requirements for client's software for one embodiment:
OS Windows 98 OSR 1, Windows Me, Windows 2000
Set of Direct Show drivers (cameras and sound cards must be compatible with the drivers)
TCP/IP protocol driver over wireless communication channel

Requirements for data communication channels for one embodiment:
digital wireless communication channel
the given wireless communication channels should provide full duplex communication with bandwidth 9600 BPS and higher
either direct dial-up connection between the two computer (or connection via Internet using ASP) or
local 10/100 MB network for direct connection between the two computers
   Video Compressor

Video Compressor carries out encoding and decoding using wavelets of video flows. The given processor has the following work cycle:
Preprocessing
Encoding of key frames
Compensating models
Decoding of key and compensated frames
Postprocessing

Preprocessing—the necessary video image preparation for the following encoding, i.e. enhancement of quality (on the basis of available from the previous frames statistics).

Encoding of key frames is carried out on the basis of developed video compression methods using wavelet technology.

Compensating methods enable to transmit greater number of frames due to the fact that only the difference between them is being transmitted. This method should be closely connected with Preprocessing. The Compensating Methods should be also closely connected to the Network Kernel, because they are mostly dependent on the network disturbances. Encoding of compensated frames is also carried out on the basis of wavelet technology.

Decoding of key and compensated frames is realized using back-encoding using wavelet technology.

Postprocessing is aimed at video quality enhancement by means of applying filters to video image for sharpness and color spectrum improvement.

In the detailed description of the invention the concrete and the most preferable realization of the method is presented. The detailed description of the method steps and their specific parameters does not on any account mean that the invention is exhausted by the presented description. The additional advantages of the claimed method and its modifications as well can be found at its realization according to the general inventive ideas of the applicants.

We claim:

1. A method of video data transmitting over low bit-rate communication channel using coding said video data as a sequence of key and predictive frames, said method comprising the steps of:
coding a frame of a frame sequence incoming from a video data source as a key frame;
transmitting a coded frame over said low bit-rate communication channel;
decoding a frame transmitted over said low bit-rate communication channel;
determining a number J of a subsequent frame F(J) assigned to coding in the frame sequence from said video data source by calculating the integer part of a ratio NQ/W, wherein N is a video data source frame rate, Q is a number of bits transmitted over said low bit-rate communication channel and W is a capacity of said communication channel;
determining a number r of a decoded frame R(r) in the frame sequence transmitted over said low bit-rate communication channel corresponding to the minimum value D1 of the difference between F(J) and R(r) frames;
coding said F(J) frame as a predictive frame with respect to R(r) frame subject to the value of D1 does not exceed a predetermined threshold value Th;
transmitting coded F(J) frame over said low bit-rate communication channel.

2. A method of video data transmitting over low bit-rate communication channel using coding said video data as a sequence of key and predictive frames, said method comprising the steps of:
coding a frame of a frame sequence incoming from a video data source as a key frame;
transmitting a coded frame over said low bit-rate communication channel;
decoding a frame transmitted over said low bit-rate communication channel;
determining a number J of a subsequent frame F(J) assigned to coding in the frame sequence from said video data source by calculating the integer part of a ratio NQ/W, where N is a video data source frame rate, Q is a number of bits transmitted over said low bit-rate communication channel and W is a capacity of said communication channel;
determining a number r of a decoded frame R(r) in the frame sequence transmitted over said low bit-rate communication channel corresponding to the minimum value D1 of the difference between F(J) and R(r) frames;
determining a number j of a frame F(j) in the frame sequence incoming from said video data source within the range of numbers J0+p(J-J0)<j<J corresponding to the minimum value D2 of the difference between F(j) and R(s) frames subject to the value of D1 exceeds a predetermined threshold value Th, wherein J0 is a number of preceding coded frame in the frame sequence incoming from said video data source, p is an adaptive parameter within the range 0<p<1; s is a number of a decoded frame R(s) in the frame sequence transmitted over said low bit-rate communication channel;
coding said F(j) frame as a predictive frame with respect to R(s) frame subject to the value of D2 does not exceed said threshold value Th;
transmitting coded F(j) frame over said low bit-rate communication channel.
